(19) United States
(12) Patent Application Publication
(10) Pub. No.: US 2026/0300036 A1
(43) Pub. Date: Oct. 1, 2026

(54) APPARATUSES AND METHODS FOR FACILITATING PRACTICAL APPLICATIONS INVOLVING AN ARTIFICIAL-INTELLIGENCE-AWARE COMPUTING AND DATA MANAGEMENT FUNCTION AS PART OF COMMUNICATION NETWORKS AND SYSTEMS

(71) Applicant: AT&T Intellectual Property I, L.P., Atlanta, GA (US)

(72) Inventors: Rohit Abhishek, Dawsonville, GA (US); Venson Shaw, Kirkland, WA (US); Farooq Bari, Kirkland, WA (US)

(73) Assignee: AT&T Intellectual Property I, L.P., Atlanta, GA (US)

(21) Appl. No.: 19/089,059

(22) Filed: Mar. 25, 2025

(51) Int. Cl. G06F 9/50

(52) U.S. Cl. CPC G06F 9/5094

(57) ABSTRACT

Aspects of the subject disclosure may include, for example, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to at least one node of a network. Other embodiments are disclosed.

### FIELD OF THE DISCLOSURE

The subject disclosure relates to apparatuses and methods for facilitating practical applications involving an artificial-intelligence-aware computing and data management function as part of communication networks and systems.

### BACKGROUND

Vast communication networks and systems, and various communication devices, are used to provision communication services. As networks/systems transition towards next-generation architectures, they face challenges in handling the complex requirements of artificial intelligence (AI)-intensive applications, such as autonomous vehicles, immersive augmented reality, and industrial Internet of Things (IoT). Many of these applications necessitate massive computing and storage resources, ultra-low latency, and high reliability, which current centralized resource management architectures struggle to deliver. Additionally, the growing complexity of network/system functions requires dynamic workload distribution and efficient policy management to provide enhanced performance and energy efficiency.

Conventional techniques rely on static resource allocation methods, which do not adequately address the dynamic and scalable needs of modern networks/systems. Additionally, centralized AI model training raises privacy concerns, rendering this approach inappropriate for applications that demand adherence to stringent data protection regulations. The absence of integrated policy management further complicates the coordination between diverse network/system functions, resulting in inefficiencies in resource utilization and quality of service mismatches. These limitations highlight the need for more sophisticated approaches.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts an illustrative embodiment of a method for facilitating a dynamic offload/onload policy creation in accordance with various aspects described herein.

FIG. 2C depicts an illustrative embodiment of a method for facilitating a subscription to a service in accordance with various aspects described herein.

FIG. 2D depicts an illustrative embodiment of a method for facilitating an adjustment to a session in accordance with various aspects described herein.

FIG. 2E depicts an illustrative embodiment of a method for facilitating an energy-aware task allocation in accordance with various aspects described herein.

FIG. 2F depicts an illustrative embodiment of a method for facilitating an energy-aware federated learning technique in accordance with various aspects described herein.

FIG. 2G depicts an illustrative embodiment of a method for facilitating a dynamic energy policy update in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments directed to techniques for facilitating practical applications involving an artificial-intelligence-aware computing and data management function as part of communication networks and systems. Other embodiments are described in the subject disclosure.

One or more aspects of the subject disclosure include, in whole or in part, obtaining a trigger; based on the obtaining of the trigger, obtaining data; processing the data to identify a resource allocation for purposes of computation and storage in conjunction with a provisioning of a communication service, resulting in an identified resource allocation; generating a policy based on the identified resource allocation; and causing the policy to be enforced, the causing resulting in an allocation of artificial intelligence, machine learning, or a combination thereof, to at least one node of a network.

One or more aspects of the subject disclosure include, in whole or in part, obtaining a trigger; based on the obtaining of the trigger, obtaining data; processing the data to identify a resource allocation for purposes of computation and storage in conjunction with a provisioning of a communication service, resulting in an identified resource allocation; generating a policy based on the identified resource allocation; and causing the policy to be enforced, the causing resulting in an allocation of artificial intelligence, machine learning, or a combination thereof, to a resource of a network.

One or more aspects of the subject disclosure include, in whole or in part, generating, by a processing system including a processor, a policy pertaining to computation, storage, and energy utilization in a network; detecting, by the processing system and in accordance with the policy, an anomaly in a parameter pertaining to a communication service supported by the network relative to a threshold, wherein the detecting is based on an analysis of data using machine learning, artificial intelligence, or a combination thereof; and adjusting, by the processing system and based on the detecting, a value of the parameter from a first value to a second value that is different from the first value.

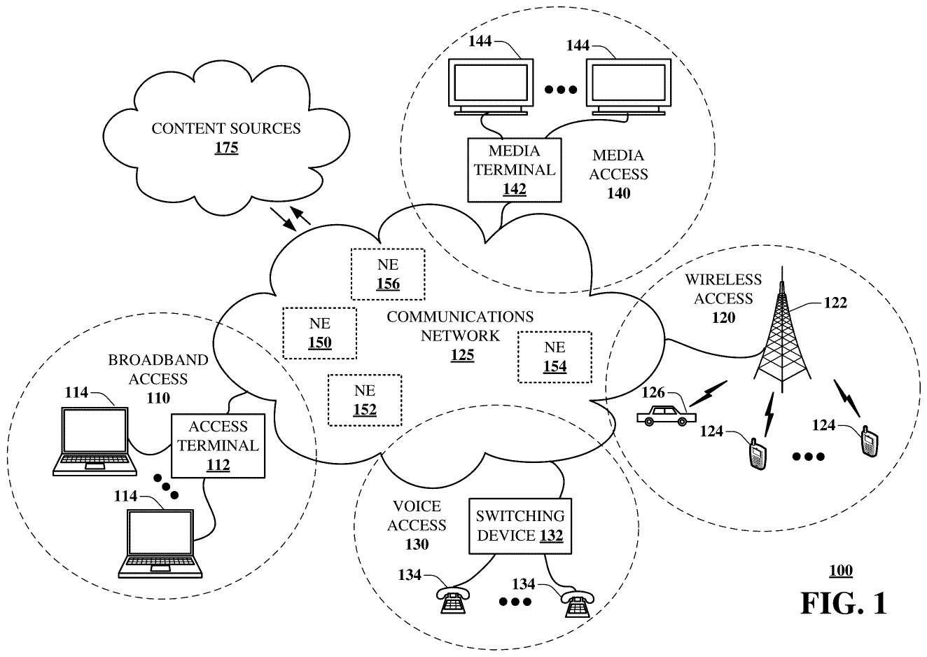

Referring now to FIG. 1, a block diagram is shown illustrating an example, non-limiting embodiment of a system 100 in accordance with various aspects described herein. For example, the system 100 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to at least one node of a network. The system 100 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to a resource of a network. The system 100 can facilitate, in whole or in part, generating, by a processing system including a processor, a policy pertaining to computation, storage, and energy utilization in a network, detecting, by the processing system and in accordance with the policy, an anomaly in a parameter pertaining to a communication service supported by the network relative to a threshold, wherein the detecting is based on an analysis of data using machine learning, artificial intelligence, or a combination thereof, and adjusting, by the processing system and based on the detecting, a value of the parameter from a first value to a second value that is different from the first value.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure are based on a recognition that as networks and systems (and associated technologies) evolve, the need for intelligent coordination between core functions becomes essential to handle the diverse demands of AI-intensive applications. An AI-aware Computing and Data Management Function (AICDMF) of this disclosure might not only manage computing and storage resources, but may also interact with other network functions or entities, such as an Access and Mobility Management Function (AMF), a Session Management Function (SMF), a User Plane Function (UPF), a Network Data Analytics Function (NWDAF), and a Unified Data Management (UDM), to ensure seamless offloading/onloading and policy enforcement. Furthermore, an AICDMF can be provisioned as a subscription-based service where multiple network/system functions can utilize its capabilities, including policy creation, protocol data unit (PDU) session management, and AI model orchestration. Key challenges and requirements shaping a need for an AICDMF in various embodiments include:
(1) Rising Complexity of AI-Driven Applications: AI-intensive applications such as autonomous vehicles, immersive augmented reality/virtual reality/extended reality (AR/VR/XR), digital twins, and industrial IoT demand massive computing and storage resources with ultra-low latency and high reliability;
(2) Latency Constraints: Applications such as real-time AR rendering or autonomous vehicle systems require latency in the range of milliseconds, which current centralized resource management architectures struggle to deliver;
(3) Energy Efficiency: Lightweight devices, critical in 6G's vision, necessitate offloading compute-intensive tasks to edge/cloud resources to conserve energy while maintaining performance;
(4) Dynamic Workload Distribution: Increasingly complex tasks require workloads to be split and distributed dynamically across network slices, edge nodes, and cloud resources for enhanced (e.g., optimal) performance;
(5) Lack of Integrated Policy Management: Existing 5G systems lack centralized, intelligent mechanisms for coordinating resource policies between diverse network functions such as AMF, SMF, NWDAF, and UDM;
(6) Federated AI Model Training Needs: Centralized AI model training is infeasible for privacy-sensitive applications (e.g., healthcare, smart cities). Federated learning offers a scalable and privacy-compliant solution;
(7) Quality of service (QoS) and Resource Availability Mismatches: QoS demands often outstrip the capacity of local resources. Real-time resource reallocation is often required to align application requirements with network capabilities;
(8) Anomaly Detection and Self-Healing: Increasing network complexity necessitates proactive mechanisms to detect and resolve faults dynamically, reducing downtime and maintaining service continuity;
(9) Data Privacy and Compliance: Ensuring user data privacy is critical in the context of stringent global regulations such as the General Data Protection Regulation (GDPR). This necessitates mechanisms like federated learning and localized decision-making;
(10) Dynamic Model Management: A network frequently must efficiently manage a variety of AI models across edge, cloud, and device layers, directing workloads to the most appropriate models in real-time based on application requirements;
(11) Interoperability with Existing Network Functions: Effective coordination with AMF, SMF, UPF, NWDAF, and UDM may be essential to create and enforce dynamic offload and onload policies that enhance (e.g., optimize) network and resource utilization;
(12) Subscription-Based Network Services: 6G networks are shifting toward modular, subscription-based services, where network functions such as AICDMF may be used to provide specialized, scalable, and on-demand services for resource and policy management.

The foregoing considerations/challenges, and others, may be addressed by aspects of this disclosure. In particular, the foregoing demonstrates the pressing need for an AICDMF in relation to next-generation networks and systems. Aspects of an AICDMF may combine AI, federated learning, and dynamic policy enforcement to provide seamless, intelligent, and scalable resource management as part of various communication networks and systems. An AICDMF may be used to provide an AI-driven resource management and policy enforcement by coordinating with other network/system functions or entities, such as the AMF, SMF, UPF, UDM, and NWDAF. Additionally, an AICDMF of this disclosure may provide several specialized services to other network functions, ensuring seamless interaction, efficient resource utilization, and enhanced (e.g., optimized) AI-driven decision-making.

An AICDMF of this disclosure may provide a number of services that may be used to enhance (e.g., optimize) network/system functionality and resource management. These services may include:
(1) Ndcsmf_AMPolicyControl, which may be used to create, update, and delete data management-related policies for AMF, and subscribe to notifications of mobility-related events, enabling dynamic policy adjustments;
(2) Ndcsmf_SMPolicyControl, which may provide session management policies to SMF for PDU sessions, and support session creations, updates, and deletions based on AI-driven decisions;
(3) Ndcsmf_PolicyAuthorization, which may authorize and create application-specific data-centric policies for PDU sessions, and coordinate with NWDAF and application functions (AFs) for task-specific analytics and resource optimization;
(4) Ndcsmf_BDTPolicyControl, which may define and enforce background data transfer policies for distributed computing and storage, and enhance (e.g., optimize) data transport between edge, cloud, and user equipment (UE) layers;
(5) Ndcsmf_UEPolicyControl, which may manage UE-specific policies, enabling distributed computing associations to network function (NF) consumers. Further, Ndcsmf_UEPolicyControl may adapt policies dynamically to match user mobility and resource demands;
(6) Ndcsmf_EventExposure, which may allow network functions (e.g., NWDAF, network exposure function (NEF)) to subscribe to and receive notifications for AICDMF events, such as resource bottlenecks, anomaly detections, and policy updates;
(7) Ndcsmf_AIModelManagement, which may manage a lifecycle of AI models, including training, deployment, and updates. Further, Ndcsmf_AIModelManagement may provide insights into model locations, performance metrics, and suitability for specific tasks;
(8) Ndcsmf_AnalyticsService, which may offer predictive analytics and performance insights to network functions based on AI or machine learning (ML) models and federated learning;
(9) Ndcsmf_EnergyOptimizationControl, which may create or establish energy-saving policies, such as workload redistribution or green node prioritization.

The foregoing services may be provided or supported by an AICDMF of this disclosure, with the understanding that such services are illustrative/exemplary. Stated differently, in some embodiments a given service may be optional, and other services not specifically mentioned may be included.

As referenced above, in some embodiments an AICDMF may support coordination with one or more network/system functions. For example, an AICDMF may coordinate with the Access and Mobility Management Function (AMF) to manage UE requests for distributed computing and storage. Upon receiving a task request, the AMF may forward the request to AICDMF via the Ndcsmf_AMPolicyControl interface. The AICDMF may evaluate the resource requirements for the task and determine whether to offload the task to the edge or cloud, based on available resources and the QoS requirements of the application.

In some embodiments, the AICDMF may interact with the Session Management Function (SMF) to establish and manage PDU sessions dynamically. Upon receiving a session request, the AICDMF may evaluate session parameters, resource availability, and AI-driven policy recommendations. The results of such an evaluation may be communicated to the SMF, which may implement the results to ensure efficient traffic routing and resource utilization. The AICDMF may (continuously) monitor conditions and update session parameters as necessary.

In some embodiments, the AICDMF may collaborate with the User Plane Function (UPF) to manage data offloading and workload distribution. The AICDMF may subscribe to event notifications from UPF instances to track resource usage and storage availability. Based on this information, the AICDMF may adjust data routing and storage allocations to enhance (e.g., optimize) network/system performance.

In some embodiments, the AICDMF may utilize a Network Data Analytics Function (NWDAF) for predictive analytics. The AICDMF may query the NWDAF for insights into resource utilization, network performance, and potential anomalies. These analytics may enhance the decision-making capabilities of the AICDMF, enabling the AICDMF to create proactive policies for resource enhancement (e.g., optimization).

In some embodiments, the AICDMF may interface with a Unified Data Management (UDM) to authenticate UE access and retrieve subscriber profiles. The UDM may provide data regarding user preferences, QoS requirements, and authorization details, enabling AICDMF to align resource allocations with user-specific needs.

The foregoing coordination functions or activities may be provided or supported by an AICDMF of this disclosure, with the understanding that such coordination functions or activities are illustrative/exemplary. Stated differently, in some embodiments a given coordination function or activity may be optional, and other coordination functions or activities not specifically mentioned may be included.

As referenced above, in some embodiments an AICDMF may support a subscription-based deployment. For example, in some embodiments an AICDMF may be provisioned as a subscription-based service. Network functions such as AMF, SMF, UPF, and NWDAF may be able to subscribe to AICDMF services to receive policy updates, event notifications, and resource insights, for example. In some embodiments, a subscription request is initiated by a network function (e.g., NWDAF) specifying the types of events and QoS parameters that the network function requires from AICDMF. Based on the request, the AICDMF may register the subscription and monitor the requested events/parameters. In some embodiments, when a relevant event (e.g., a resource bottleneck or a policy update) is detected, an AICDMF notifies the subscribed function through the Ndcsmf_EventExposure service/interface. The notification may include actionable recommendations or updated policies for the subscribed function to implement.

In some embodiments, an AICDMF may implement a procedure for dynamic policy creation. For example, upon receiving a resource request from a UE or an application, the AICDMF may query the UDM to retrieve one or more subscriber profiles and/or QoS parameters. The AICDMF may coordinate with the NWDAF to obtain real-time analytics on network performance and resource utilization. Based on the data obtained from the UDM and/or the NWDAF (or any other function or entity), the AICDMF may utilize an AI/ML engine to create a policy that specifies: a resource allocation to edge, cloud, or device layers, traffic routing strategies, and/or task offloading/onloading decisions. The policy may be communicated to, e.g., the SMF and AMF for enforcement purposes.

In some embodiments, an AICDMF may manage one or more sessions (e.g., one or more PDU sessions). In this respect, the AICDMF may support an establishment of a session. For example, upon receiving a session establishment request, a SMF may forward the request to the AICDMF. The AICDMF may evaluate the session requirements and assign resources based on its policies. The session may be established, and traffic may be routed pursuant to directives/commands established by the AICDMF.

The management of a session may include updating a session or terminating a session. Session updates may involve a detection of a change in network/system conditions. Based on such a change, the AICDMF may recalculate session parameters. Updated policies may be sent to a SMF, which may enforce the updated policies, potentially in real-time. In terms of session termination, when a session ends the AICDMF may ensure that any (e.g., all) associated resources are released and may update a resource registry accordingly.

In some embodiments, an AICDMF may include a centralized AI model registry to catalog available models, their capabilities, and locations. This registry may be used to identify and allocate models for various tasks, including policy generation/create and/or refinement/modification of such policies. For example, an AICDMF may incorporate a decision module to evaluate and allocate the best-fit model for a given task. The decision may be based on parameters such as model accuracy, latency, and resource availability. In some instances, the AICDMF may dynamically update model preferences and rankings based on real-time feedback from task executions.

In some embodiments, an AICDMF manages the lifecycle of AI models. Such management may include training and updating models via federated learning protocols, deploying models to edge, cloud, or device layers based on demand, and/or monitoring model performance and replacing underperforming models with suitable alternatives.

In some embodiments, an AICDMF may integrate energy-saving mechanisms across its operational layers. These functionalities/mechanisms may include:
(1) Energy-aware resource allocations, which may include an AICDMF evaluating energy consumption metrics alongside resource availability when assigning tasks to edge, cloud, or device layers, where tasks requiring reduced (e.g., minimal) latency may be allocated to local edge nodes with higher energy efficiency, while less time-sensitive tasks may be routed to cloud resources where energy costs are enhanced (e.g., optimized) through economies of scale;
(2) Dynamic workload distribution, which may involve an AICDMF using AI/ML algorithms to analyze real-time energy usage patterns across network nodes and devices, and may include a dynamic distribution of workloads to reduce (e.g., minimize) energy consumption by offloading tasks to underutilized resources or energy-efficient nodes;
(3) Federated learning with energy constraints, which may include an enhancement (e.g., optimization) of federated learning cycles by reducing communication overhead. In some instances, an AICDMF selects only relevant nodes with sufficient energy reserves for participating in model training, ensuring that low-energy devices are not overburdened;
(4) AI-Driven energy policies, in which an AICDMF creates and enforces policies that prioritize low-energy modes during periods of reduced network/system activity. In this respect, non-critical background data transfers may be deferred to off-peak times to reduce energy consumption;
(5) Energy-Efficient AI Model Deployment, in which an AICDMF may maintain a registry of energy profiles for AI models and their locations. When allocating models, the AICDMF may consider both computational performance and energy efficiency, ensuring tasks are assigned to models with enhanced (e.g., optimized) energy profiles;
(6) Green edge and cloud integration, in which an AICDMF may integrate with green energy sources (e.g., renewable-powered data centers or edge nodes) where available. Tasks may be prioritized for execution on nodes powered by sustainable energy sources to further reduce carbon emissions;
(7) Device-Level energy management, in which an AICDMF may communicate with a UE to monitor energy levels and adjust resource allocation to prevent battery depletion. Tasks may be offloaded to nearby edge or cloud nodes when device energy reserves fall below a predefined threshold;
(8) Anomaly detection for energy inefficiencies, in which an AICDMF may utilize real-time analytics (from, e.g., an NWDAF) to identify anomalies in energy usage, such as underperforming devices or energy-intensive application. Policies may be dynamically adjusted to mitigate inefficiencies, such as rerouting traffic away from energy-hungry nodes.

To demonstrate aspects of the foregoing by way of example, it may be assumed that a VR/AR application requires low latency for real-time interactions. An AICDMF may evaluate edge nodes within the application's vicinity, selecting nodes with both sufficient computing capacity and optimal energy efficiency to reduce (e.g., minimize) power consumption. In another example, and during off-peak hours, an AICDMF may schedule non-critical data transfers to nodes with surplus energy capacity, such as cloud servers using renewable energy sources; this may reduce peak-time energy loads and optimize overall energy consumption profiles. In yet another example, an IoT device with limited battery life may offload processing tasks to nearby edge servers managed by an AICDMF; by optimizing the offload frequency and data size, the AICDMF may extend the operational lifespan of the IoT device.

As set forth above, an AICDMF may be utilized as part of practical applications to reduce energy consumption. For example, intelligent task allocations may reduce energy consumption, which in turn may reduce operational costs for a network/system operator or service provider. Optimizations in terms of offloading and workload distributions may preserve battery life for UEs and IoT devices. Integration with green energy sources may support environmentally sustainable operations. AI-driven policies may ensure resources are used efficiently, balancing energy savings with performance. Early identification of energy inefficiencies may help to prevent wastage and ensure consistent service delivery.

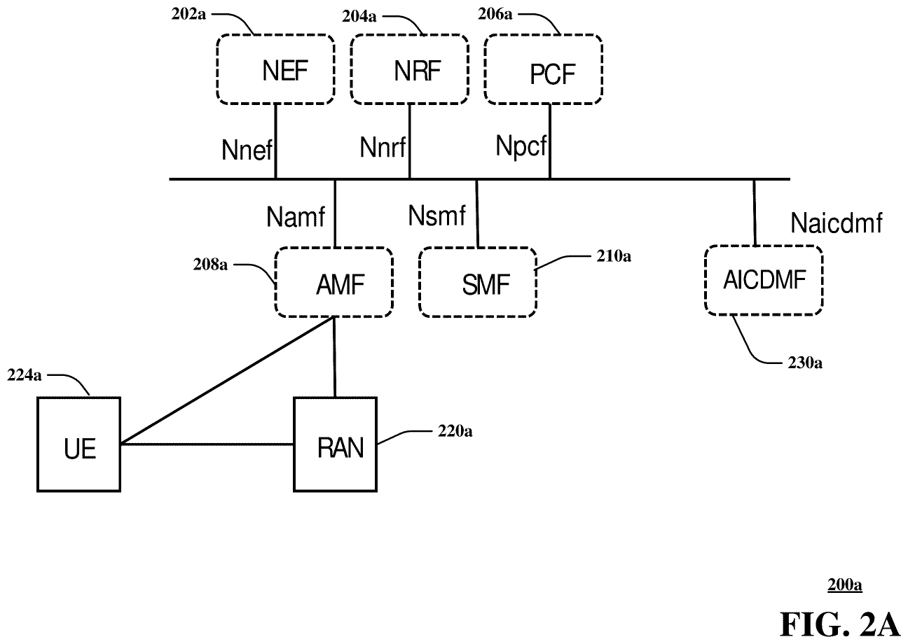

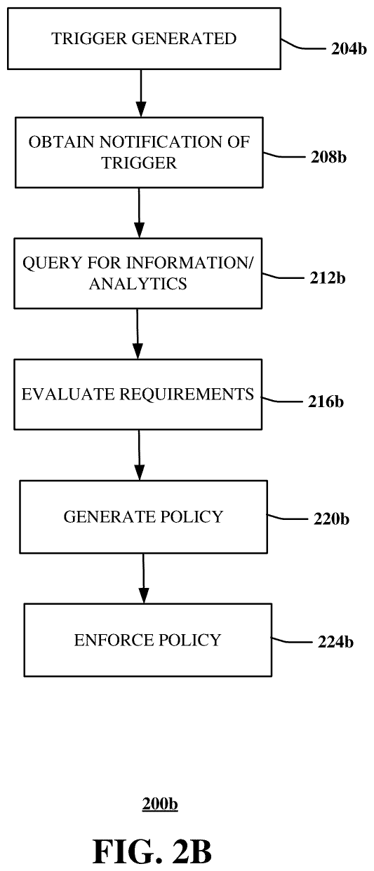

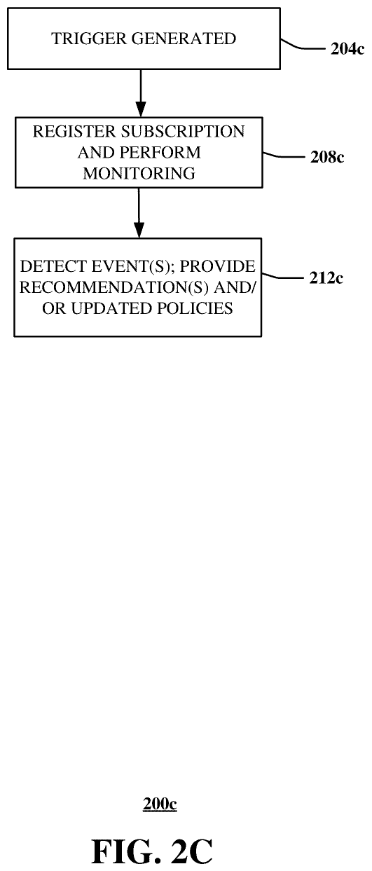

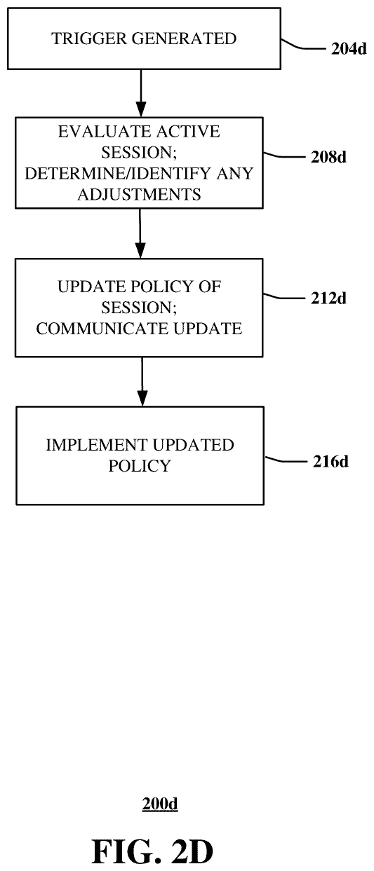

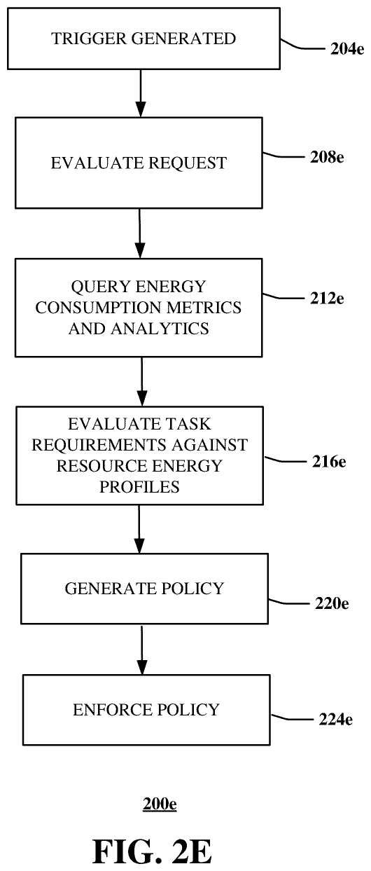

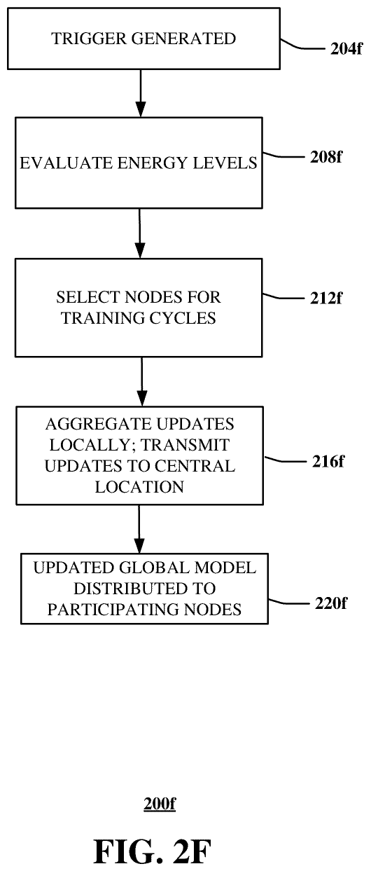

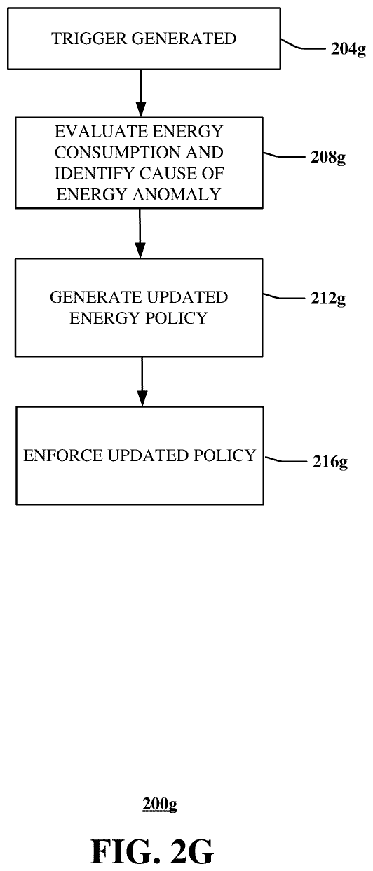

With the foregoing in mind, reference may now be made to FIG. 2A, which is a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1. The system 200a may include a number of functions, such as a network exposure function (NEF) 202a (and corresponding interface Nnef), a network repository function (NRF) 204a (and corresponding interface Nnrf), a policy control function (PCF) 206a (and corresponding interface Npcf), an access and mobility management function (AMF) 208a (and corresponding interface Namf), and a session management function (SMF) 210a (and corresponding interface Nsmf). The AMF 208a may be communicatively coupled with a radio access network (RAN) 220a and/or a user equipment (UE) 224a.

The system 200a may also include an AICDMF 230a (and corresponding interface Naicdmf). The AICDMF 230a may interact with other functions (e.g., functions 202a through 210a set forth above) and may support/provide one or more functionalities as described herein. The Naicdmf interface may facilitate dynamic AI-driven policy management, allowing the AICDMF 230a to enhance (e.g., optimize) resource allocation for computing, storage and energy efficiency. The Naicdmf interface may facilitate federated learning coordination, enabling distributed AI model training across edge and cloud nodes. The Naicdmf interface may facilitate real-time analytics and anomaly detection, supporting proactive network/system adjustments. The Naicdmf interface may enable AI model lifecycle management, ensuring that best-fit AI models are allocated for specific tasks. Through the Naicdmf interface, the AICDMF 230a may exchange data with other entities/functions (e.g., AMF, SMF, UPF, NWDAF, UDM), thereby enhancing network/system intelligence and efficiency while introducing AI-based automation into core network/system operations.

Referring now to FIG. 2B, an illustrative embodiment of a method 200b in accordance with various aspects described herein is shown. The method 200b may be implemented or executed, in whole or in part, in conjunction with one or more systems, devices, and/or components, such as for example the systems, devices, and components set forth herein. In some embodiments, the method 200b may be wholly or partially implemented or executed via one or more processing systems, where each such processing system may include one or more processors. Further, in some embodiments, operations of the method 200b may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200b are described below in relation to the blocks shown in FIG. 2B. In some embodiments, one or more blocks or operations may be based on one or more other blocks or operations. The method 200b may be used to support/facilitate a dynamic offload/onload policy creation.

In block 204b, a trigger may be generated. For example, as part of block 204b a UE may request a resource-intensive task.

In block 208b, a notification of the trigger may be obtained by, e.g., an AICDMF. For example, as part of block 208b an AMF may forward the request (of block 204b) to the AICDMF.

In block 212b, the AICDMF may query, e.g., a UDM for subscriber and QoS information. As part of block 212b, the AICDMF may query a NWDAF for real-time analytics.

In block 216b, the AICDMF may evaluate any requirements associated with the task and determine whether to offload (a responsibility associated with) the task to an edge resource, a cloud resource, or retain it for purposes of the UE.

In block 220b, the AICDMF may generate a policy specifying resource allocations and routing instructions.

In block 224b, the policy may be enforced. For example, as part of block 224b the AICDMF may command or directed a SMF and/or the AMF to enforce the policy, resulting in an execution of the task.

Referring now to FIG. 2C, an illustrative embodiment of a method 200c in accordance with various aspects described herein is shown. The method 200c may be implemented or executed, in whole or in part, in conjunction with one or more systems, devices, and/or components, such as for example the systems, devices, and components set forth herein. In some embodiments, the method 200c may be wholly or partially implemented or executed via one or more processing systems, where each such processing system may include one or more processors. Further, in some embodiments, operations of the method 200c may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200c are described below in relation to the blocks shown in FIG. 2C. In some embodiments, one or more blocks or operations may be based on one or more other blocks or operations. The method 200c may be used to support/facilitate a subscription to AICDMF services.

In block 204c, a trigger may be generated. For example, as part of block 204c a subscription request may be obtained. The subscription request may correspond to a request for policy notifications. The subscription request may originate from one or more entities or functions, e.g., a NWDAF. The subscription request may correspond to, or specify, one or more required events and/or QoS parameters.

In block 208c, the AICDMF may register the subscription request and monitor the requested event(s).

In block 212c, a detection of an occurrence of the requested event(s) may be obtained. When such a situation arises, the AICDMF may notify, e.g., the NWDAF of the event(s) and may provide the NWDAF with recommendations and/or updated/modified policies.

Referring now to FIG. 2D, an illustrative embodiment of a method 200d in accordance with various aspects described herein is shown. The method 200d may be implemented or executed, in whole or in part, in conjunction with one or more systems, devices, and/or components, such as for example the systems, devices, and components set forth herein. In some embodiments, the method 200d may be wholly or partially implemented or executed via one or more processing systems, where each such processing system may include one or more processors. Further, in some embodiments, operations of the method 200d may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200d are described below in relation to the blocks shown in FIG. 2D. In some embodiments, one or more blocks or operations may be based on one or more other blocks or operations. The method 200d may be used to support/facilitate an adjustment to a session (e.g., a PDU session).

In block 204d, a trigger may be generated. For example, as part of block 204d an AICDMF may detect a change in one or more network/system conditions.

In block 208d, the AICDMF may evaluate an active session and determine any necessary or needed adjustments.

In block 212d, the AICDMF may update a policy of the session and communicate the update to, e.g., a SMF.

In block 216d, the SMF may implement the updated policy.

Referring now to FIG. 2E, an illustrative embodiment of a method 200e in accordance with various aspects described herein is shown. The method 200e may be implemented or executed, in whole or in part, in conjunction with one or more systems, devices, and/or components, such as for example the systems, devices, and components set forth herein. In some embodiments, the method 200e may be wholly or partially implemented or executed via one or more processing systems, where each such processing system may include one or more processors. Further, in some embodiments, operations of the method 200e may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200e are described below in relation to the blocks shown in FIG. 2E. In some embodiments, one or more blocks or operations may be based on one or more other blocks or operations. The method 200e may be used to support/facilitate an energy-aware task allocation.

In block 204e, a trigger may be generated. For example, as part of block 204e an application function (AF) may request processing for a resource-intensive task.

In block 208e, an AICDMF may evaluate the request. The request may be forwarded to the AICDMF by, e.g., a SMF.

In block 212e, the AICDMF may query, e.g., a NWDAF for energy consumption metrics and real-time analytics available from edge and cloud computing resources (or other resources).

In block 216e, the AICDMF may evaluate task requirements against resource energy profiles and select the most energy-efficient node.

In block 220e, the AICDMF may generate a policy specifying task routing and resource allocations.

In block 224e, the policy may be enforced. For example, as part of block 224e the AICDMF may command or direct a SMF to enforce the policy, which may result in the task being executed on a selected resource.

Referring now to FIG. 2F, an illustrative embodiment of a method 200f in accordance with various aspects described herein is shown. The method 200f may be implemented or executed, in whole or in part, in conjunction with one or more systems, devices, and/or components, such as for example the systems, devices, and components set forth herein. In some embodiments, the method 200f may be wholly or partially implemented or executed via one or more processing systems, where each such processing system may include one or more processors. Further, in some embodiments, operations of the method 200f may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200f are described below in relation to the blocks shown in FIG. 2F. In some embodiments, one or more blocks or operations may be based on one or more other blocks or operations. The method 200f may be used to support/facilitate an energy-aware federated learning technique.

In block 204f, a trigger may be generated. For example, as part of block 204f an AICDMF may initiate a federated learning cycle to update an AI model.

In block 208f, the AICDMF may evaluate energy levels of potential participant nodes. The participant nodes may include an edge node or device, a cloud computing node, or the like.

In block 212f, nodes with sufficient energy reserves and computing capacity (as potentially expressed relative to one or more thresholds) may be selected for a training cycle.

In block 216f, the AICDMF may enhance (e.g., optimize) communication overhead by aggregating updates locally before transmitting them to a central location/aggregator.

In block 220f, the updated central/global model may be distributed back to the participating nodes for deployment/execution purposes.

Referring now to FIG. 2G, an illustrative embodiment of a method 200g in accordance with various aspects described herein is shown. The method 200g may be implemented or executed, in whole or in part, in conjunction with one or more systems, devices, and/or components, such as for example the systems, devices, and components set forth herein. In some embodiments, the method 200g may be wholly or partially implemented or executed via one or more processing systems, where each such processing system may include one or more processors. Further, in some embodiments, operations of the method 200g may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200g are described below in relation to the blocks shown in FIG. 2G. In some embodiments, one or more blocks or operations may be based on one or more other blocks or operations. The method 200g may be used to support/facilitate a dynamic energy policy update.

In block 204g, a trigger may be generated. For example, as part of block 204g an AICDMF may detect an energy usage anomaly in a given node. Block 204g may include the AICDMF obtaining analytics data from, e.g., a NWDAF and comparing the data to/with one or more thresholds.

In block 208g, the AICDMF may evaluate energy consumption and identify a cause of the anomaly (e.g., an inefficient task or device). As part of block 208g, AI and/or ML may be utilized. Block 208g may incorporate one or more algorithms or models to identify the cause.

In block 212g, the AICDMF may generate an updated energy policy, rerouting tasks to more energy-efficient nodes.

In block 216g, the AICDMF may cause the policy to be implemented or enforced. For example, as part of block 216g the AICDMF may command or direct a SMF or AMF to enforce the policy.

While for purposes of simplicity of explanation, the respective processes are shown and described as a series of blocks in FIGS. 2B, 2C, 2D, 2E, 2F, and 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. While the methods 200b, 200c, 200d, 200e, 200f, and 200g were described and shown separately, in some embodiments one or more aspects of a given method may be combined with one or more aspects of one or more of the other methods.

Various embodiments of this disclosure may be utilized to adapt parameters (or values thereof) associated with a communication service or session. Such parameters may include, or pertain to, communication frequencies or frequency bands, transmission power levels, receiver sensitivity levels, modulation/demodulation schemes, encryption/decryption schemes, encoding/decoding schemes, and the like.

Aspects of this disclosure may be executed iteratively or repeatedly. For example, as new or updated data or information becomes available, such updates may be analyzed (potentially relative to a historical record) to determine/identify whether any changes or modifications are warranted. To the extent that such modifications or changes are warranted, the same may be effectuated. For example, an update to a policy may be enforced, and one or more commands, directives, or instructions may cause the updated policy to be enforced.

Aspects of this disclosure may effectively transform a communication network or system into its own AI or ML based intelligence. For example, aspects of this disclosure may allow/enable a network/system to identify, trigger, analyze, and manage data related to AI or ML, effectively integrating AI/ML functions directly into the network/system infrastructure. Unlike conventional techniques, which may perform analytics and predictions, aspects of this disclosure progress to intelligent decision-making in resource allocation, utilizing virtualization to distribute compute, storage, and communication resources across the network/system. This disclosure provides/facilitates a coherent solution/technique to the fragmented approach of existing technologies by introducing control over the network/system to make intelligent decisions. This approach enables the network/system to perform AI functions using, e.g., GPUs and CPUs, thereby enhancing the capability of the network/system to manage resources dynamically and efficiently.

As demonstrated herein, aspects of this disclosure represent substantial improvements to technologies as part of practical applications involving a provisioning of communication services and sessions. The results that are obtained from implementing aspects of this disclosure are useful, concrete, tangible and transformative in nature. In this respect, one of skill in the art will appreciate based on a review of this disclosure that the various aspects of this disclosure are not directed to abstract ideas. To the contrary, the various aspects of this disclosure are directed to, and encompass, significantly more than any abstract idea standing alone.

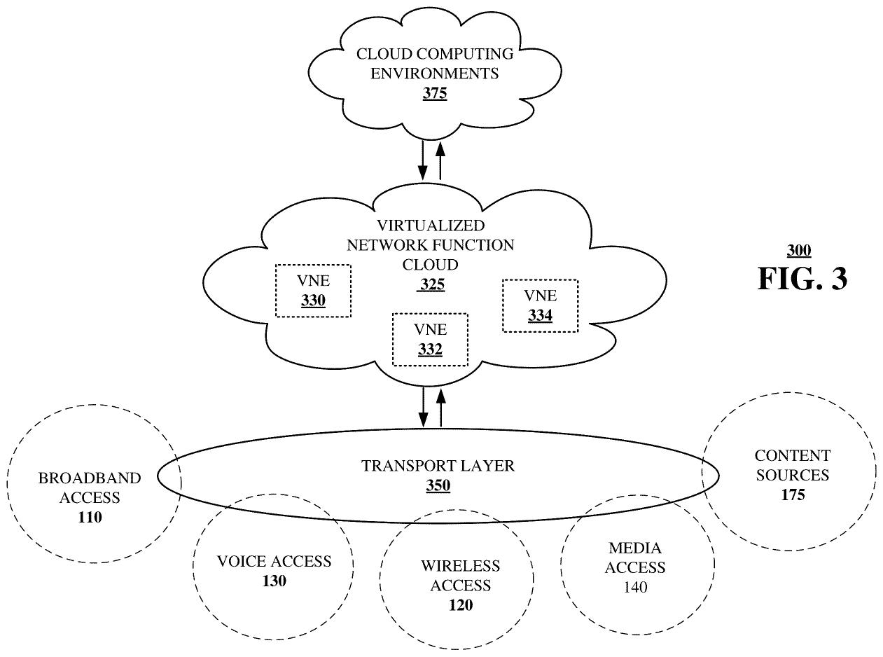

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and methods 200b, 200c, 200d, 200e, 200f, and 200g presented in FIGS. 1, 2A, 2B, 2C, 2D, 2E, 2F, and 2G. For example, the virtualized communication network 300 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to at least one node of a network. The virtualized communication network 300 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to a resource of a network. The virtualized communication network 300 can facilitate, in whole or in part, generating, by a processing system including a processor, a policy pertaining to computation, storage, and energy utilization in a network, detecting, by the processing system and in accordance with the policy, an anomaly in a parameter pertaining to a communication service supported by the network relative to a threshold, wherein the detecting is based on an analysis of data using machine learning, artificial intelligence, or a combination thereof, and adjusting, by the processing system and based on the detecting, a value of the parameter from a first value to a second value that is different from the first value.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

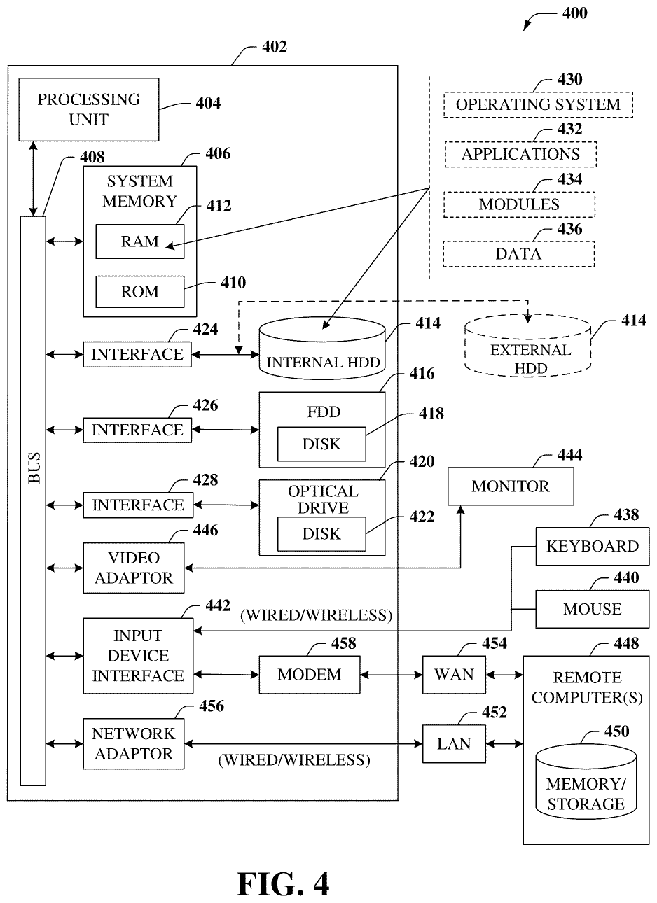

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to at least one node of a network. The computing environment 400 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to a resource of a network. The computing environment 400 can facilitate, in whole or in part, generating, by a processing system including a processor, a policy pertaining to computation, storage, and energy utilization in a network, detecting, by the processing system and in accordance with the policy, an anomaly in a parameter pertaining to a communication service supported by the network relative to a threshold, wherein the detecting is based on an analysis of data using machine learning, artificial intelligence, or a combination thereof, and adjusting, by the processing system and based on the detecting, a value of the parameter from a first value to a second value that is different from the first value.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

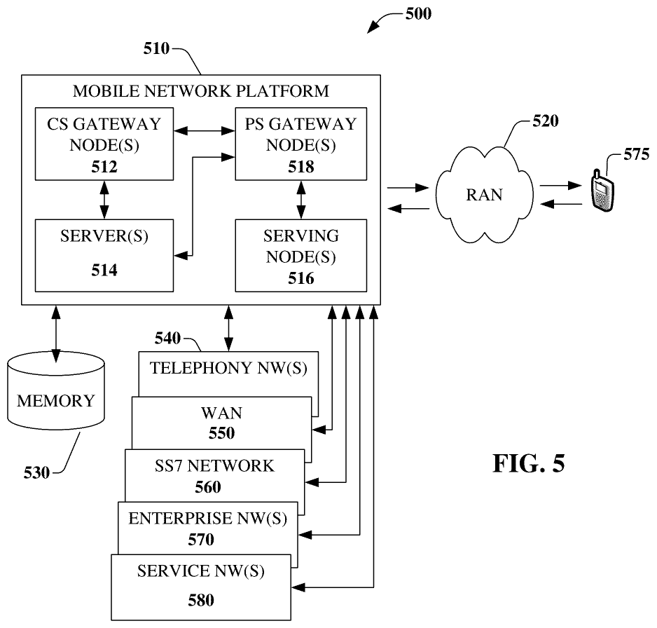

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to at least one node of a network. The platform 510 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to a resource of a network. The platform 510 can facilitate, in whole or in part, generating, by a processing system including a processor, a policy pertaining to computation, storage, and energy utilization in a network, detecting, by the processing system and in accordance with the policy, an anomaly in a parameter pertaining to a communication service supported by the network relative to a threshold, wherein the detecting is based on an analysis of data using machine learning, artificial intelligence, or a combination thereof, and adjusting, by the processing system and based on the detecting, a value of the parameter from a first value to a second value that is different from the first value.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

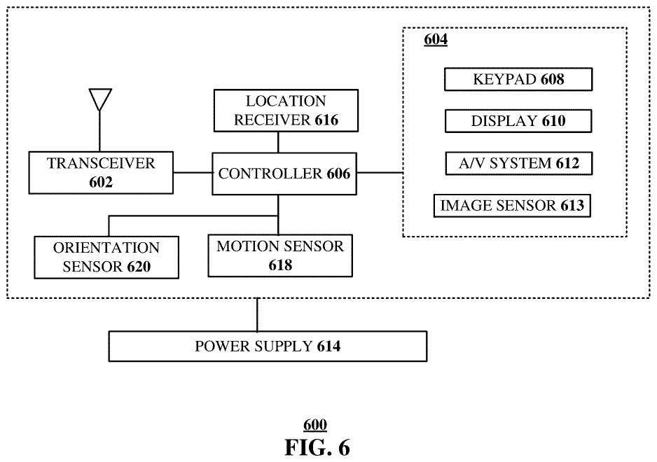

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to at least one node of a network. The computing device 600 can facilitate, in whole or in part, obtaining a trigger, based on the obtaining of the trigger, obtaining data, processing the data to identify a resource allocation for purposes of computation and storage in conjunction with a provisioning of a communication service, resulting in an identified resource allocation, generating a policy based on the identified resource allocation, and causing the policy to be enforced, the causing resulting in an allocation of artificial intelligence, machine learning, or a combination thereof, to a resource of a network. The computing device 600 can facilitate, in whole or in part, generating, by a processing system including a processor, a policy pertaining to computation, storage, and energy utilization in a network, detecting, by the processing system and in accordance with the policy, an anomaly in a parameter pertaining to a communication service supported by the network relative to a threshold, wherein the detecting is based on an analysis of data using machine learning, artificial intelligence, or a combination thereof, and adjusting, by the processing system and based on the detecting, a value of the parameter from a first value to a second value that is different from the first value.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee®are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a trigger;
based on the obtaining of the trigger, obtaining data;
processing the data to identify a resource allocation for purposes of computation and storage in conjunction with a provisioning of a communication service, resulting in an identified resource allocation;
generating a policy based on the identified resource allocation; and
causing the policy to be enforced, the causing resulting in an allocation of artificial intelligence, machine learning, or a combination thereof, to at least one node of a network.

2. The device of claim 1, wherein the obtaining of the trigger comprises obtaining a request from a user equipment in respect of a task.

3. The device of claim 2, wherein the obtaining of the data comprises obtaining real-time analytics and quality of service (QoS) information.

4. The device of claim 2, wherein the processing of the data comprises evaluating a requirement of the task and determining whether to offload a responsibility associated with the task to an edge resource or a cloud resource.

5. The device of claim 1, wherein the obtaining of the trigger comprises obtaining a subscription request from a network function of the network, the subscription request pertaining to a request for policy notifications.

6. The device of claim 5, wherein the operations further comprise:
registering the subscription request; and
detecting, based on the registering, an occurrence of an event associated with the subscription request.

7. The device of claim 6, wherein the operations further comprise:
modifying, based on the detecting, the policy, resulting in a modified policy; and
causing the modified policy to be enforced.

8. The device of claim 1, wherein the obtaining of the trigger comprises detecting a change in a condition of the network.

9. The device of claim 8, wherein the operations further comprise:
modifying, based on the detecting, the policy, resulting in a modified policy; and
causing the modified policy to be enforced, the causing of the modified policy to be enforced including updating a second policy of a session associated with the communication service.

10. The device of claim 1, wherein the data includes first data pertaining to energy consumption metrics.

11. The device of claim 10, wherein the data includes second data pertaining to real-time analytics available from edge and cloud computing resources.

12. The device of claim 10, wherein the energy consumption metrics include an identification of energy reserves and computing capacity in respect of each of a plurality of nodes, the plurality of nodes including the node.

13. The device of claim 12, wherein the operations further comprise:
selecting, based on the energy consumption metrics, a first plurality of nodes included in the plurality of nodes to partake in a training cycle in respect of a model;
performing, based on the selecting, the training cycle;
modifying, based on the performing of the training cycle, the model at a central node, resulting in a modified model; and
distributing the modified model from the central node to at least the first plurality of nodes.

14. The device of claim 1, wherein the obtaining of the trigger comprises detecting an anomaly in an energy usage associated with the node or a second node of the network.

15. The device of claim 14, wherein the operations further comprise:
identifying a cause of the anomaly;
modifying the policy based on the identifying of the cause of the anomaly, resulting in a modified policy; and
causing the modified policy to be enforced.

16. A non-transitory machine-readable medium, comprising executable instructions that, when executed by a processing system including a processor, facilitate performance of operations, the operations comprising:
obtaining a trigger;
based on the obtaining of the trigger, obtaining data;
processing the data to identify a resource allocation for purposes of computation and storage in conjunction with a provisioning of a communication service, resulting in an identified resource allocation;
generating a policy based on the identified resource allocation; and
causing the policy to be enforced, the causing resulting in an allocation of artificial intelligence, machine learning, or a combination thereof, to a resource of a network.

17. The non-transitory machine-readable medium of claim 16, wherein the resource of the network includes a node, an application, a function, or any combination thereof.

18. The non-transitory machine-readable medium of claim 16, wherein the communication service involves a user equipment, and wherein the causing of the policy to be enforced comprises selecting a value for a parameter of a radio access network of the network that is communicatively coupled to the user equipment.

19. A method, comprising:
generating, by a processing system including a processor, a policy pertaining to computation, storage, and energy utilization in a network;
detecting, by the processing system and in accordance with the policy, an anomaly in a parameter pertaining to a communication service supported by the network relative to a threshold, wherein the detecting is based on an analysis of data using machine learning, artificial intelligence, or a combination thereof; and
adjusting, by the processing system and based on the detecting, a value of the parameter from a first value to a second value that is different from the first value.

20. The method of claim 19, further comprising:
enabling, by the processing system, a training of a model across a distribution of a plurality of nodes of the network, the plurality of nodes including edge and cloud nodes; and
obtaining, by the processing system, results from the training,
wherein the generating of the policy is based on the results.
